(19) United States
(12) Patent Application Publication
(10) Pub. No.: US 2008/0184894 A1
(43) Pub. Date: Aug. 7, 2008

(54) Filter Alert Device

(75) Inventor: George P. Grundelman, Grass Lake, MI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: INTER BASIC RESOURCES, INC., Grass Lake, MI (US)

(21) Appl. No.: 11/815,295

(22) PCT Filed: Feb. 1, 2006
(86) PCT No.: PCT/US2006/003389

§ 371 Date: Aug. 1, 2007

Related U.S. Application Data
(60) Provisional application No. 60/650,317, filed on Feb. 4, 2005.

(51) Int. Cl. B01D 35/143

(52) U.S. Cl. 96/421

(57) ABSTRACT

A filter alert device (10) for use in forced air systems (50) used to distribute conditioned air comprises an indicator that operates with an air filter (30) supported by a register (50). The filter (30) and filter alert indicator (16) have cavities in communication with at least a portion of the air passing through the filter (30). The air pressure varies in response to the flow through the filter (30) and exceeds a predetermined pressure when the air is unable to flow through the filter (30) at desired pressure levels and the life of the filter has been exceeded. In one embodiment, the indicator (16) is attached to a frame for movement between closed and open positions wherein the indicator (16) remains in closed position to show that the filter (30) is operating within desired operating parameters, and the indicator (16) is positioned to the open position that projects out of the register to alert users that the filter is no longer operating within the desired operating parameters and should be replaced or cleaned. A pressure sensitive attachment element holds the indicator in the closed position when the pressure is below the predetermined pressure and the filter is operating within desired parameters, and releases the indicator when the pressure exceeds the predetermined pressure and the filter is no longer operating within desired operating parameters.

### CROSS-REFERENCE TO RELATED APPLICATIONS

This patent application claims the benefit of U.S. Provisional Patent Application No. 60/650,317, filed Feb. 4, 2005, which is herein incorporated by reference.

### FIELD OF THE INVENTION

The present invention generally relates to air filtration and, more particularly, to a filter alert device.

### BACKGROUND OF THE INVENTION

Air circulation within enclosed environments is an important design consideration for many industrial and domestic heating, ventilation and air conditioning (HVAC) products and systems. Circulated air often contains contaminants and other particulates that may degrade air quality and exacerbate medical conditions, such as allergies and asthma, for those individuals living and/or working under those conditions. Consequently, it is beneficial to provide the cleanest conditioned air.

HVAC products and systems that use forced air for heating, cooling and ventilating buildings often have replaceable filters for removing undesirable contaminants from the conditioned air. To improve air quality and reduce undesirable contaminants, these replaceable filters are typically located in registers in floors, walls, and ceilings, or in registers incorporated within stand-alone HVAC units. The filter is typically located on the interior side of the register to conceal it from view and present an aesthetically pleasing profile. Unfortunately, concealing the filter from view also prevents users from easily recognizing that the filter has become dirty and contaminated, and may require maintenance and/or replacement. Contaminated and clogged filters may cause reduced air flow, filtration and HVAC system efficiency, and difficulty in maintaining desired temperatures and cleanliness. The inability to quickly assess the condition of the filter may detrimentally impact the overall HVAC system, increase maintenance costs and, in some cases, cause system failure.

In addition to HVAC systems, filters are also used in many devices, such as vacuum cleaners, that require unimpeded air flow for proper functioning. Like HVAC systems, concealing the filter from view inside the device prevents users from easily recognizing that the filter has become dirty and contaminated, and may require maintenance and/or replacement. The inability to quickly assess the condition of the filter may result in contaminated and clogged filters which may cause reduced air flow, device efficiency and increase maintenance costs and, in some cases, cause system failure.

Past attempts to provide adequate notice about the general condition of a replaceable filter have been unsuccessful. Devices used to monitor the condition of filters in certain products, such as vacuum cleaners, are not useable and/or are incapable of providing sufficient protection in HVAC systems. Other devices incorporated directly into the HVAC system itself, often require expensive and complicated technology that, unfortunately, creates a system prone to malfunction, particularly as the system ages. Many devices function at high pressure differentials, not the low pressure differential found in many devices and HVAC systems. Many other devices also operate only when the device or HVAC system is in operation.

### SUMMARY OF PREFERRED EMBODIMENTS OF THE INVENTION

The present invention comprises a filter alert device for use in forced air systems used to distribute conditioned air and in vacuum cleaners and other devices whose operation depends on unimpeded air flow for proper functioning. In one embodiment, the filter alert device comprises a filter alert indicator that operates with an air filter supported by a housing such as a register typically mounted in a ceiling, floor, or wall. The filter and filter alert indicator have cavities in communication with at least a portion of the air passing through the filter. The air pressure varies in response to the flow through the filter and exceeds a predetermined pressure when the air is unable to flow through the filter at desired pressure levels and the life of the filter has been exceeded. In one embodiment, the filter alert indicator is attached to a frame for movement between closed and open positions wherein (1) the indicator remains in closed position to show that the filter is operating within desired operating parameters, and (2) the indicator is positioned to the open position that projects out of the register to alert users that the filter is no longer operating within desired operating parameters and should be replaced or cleaned. A pressure sensitive attachment element (1) holds the indicator in the closed position when the pressure is below the predetermined pressure and the filter is operating within desired parameters, and (2) releases the indicator when the pressure exceeds the predetermined pressure and the filter is no longer operating within desired operating parameters. The filter alert device may also be adapted for use in vacuum cleaners and other devices that have housings similar to the register and replaceable filters and could benefit from the features mentioned for registers.

### BRIEF DESCRIPTION OF THE DRAWINGS

For the purpose of illustrating the invention, the drawings show a presently preferred embodiment of the invention. However, it should be understood that the present invention is not limited to the precise arrangements and instrumentalities shown in the various embodiments in the drawings.

FIG. 1 is a perspective view of one embodiment of the present invention showing the front of a register, a filter partially inserted into a filter housing, and a filter alert device and indicator;

FIG. 2 is a perspective view of the embodiment in FIG. 1, showing the rear of the register and the filter alert device, the filter housing in an open position, and the filter fully inserted into the filter housing;

FIG. 3 is a perspective view of the embodiment in FIG. 1, showing the rear of the register, the filter housing in an open position, the filter outside of the housing, and the filter alert device and indicator at one end of the filter;

FIG. 4 is a perspective view of the embodiment in FIG. 1, showing the register, the filter housing in the closed position, and the filter device with the indicator standing in the open position;

FIG. 5 is a perspective view of the filter and the filter alert and indicator in the open position;

FIG. 6 is a cross-section taken along line 6-6 in FIG. 5, showing the indicator in the open position;

FIG. 7 is a cross-section similar to FIG. 6, but showing the indicator in the closed position;

FIG. 8 is another embodiment of the invention showing the filter alert device and another embodiment of the indicator in the closed position;

FIGS. 9-10 is another embodiment of the invention showing the filter alert device and another embodiment of the indicator in the open and closed positions, respectively; and

FIGS. 11 and 12 show the filter alert device in a vacuum cleaner, wherein the illustrated embodiment of the indicator is a tape type that is in the closed position in FIGS. 11a-b and fluttering in the open position in FIGS. 12a-b.

### DETAILED DESCRIPTION OF PREFERRED EMBODIMENTS OF THE INVENTION

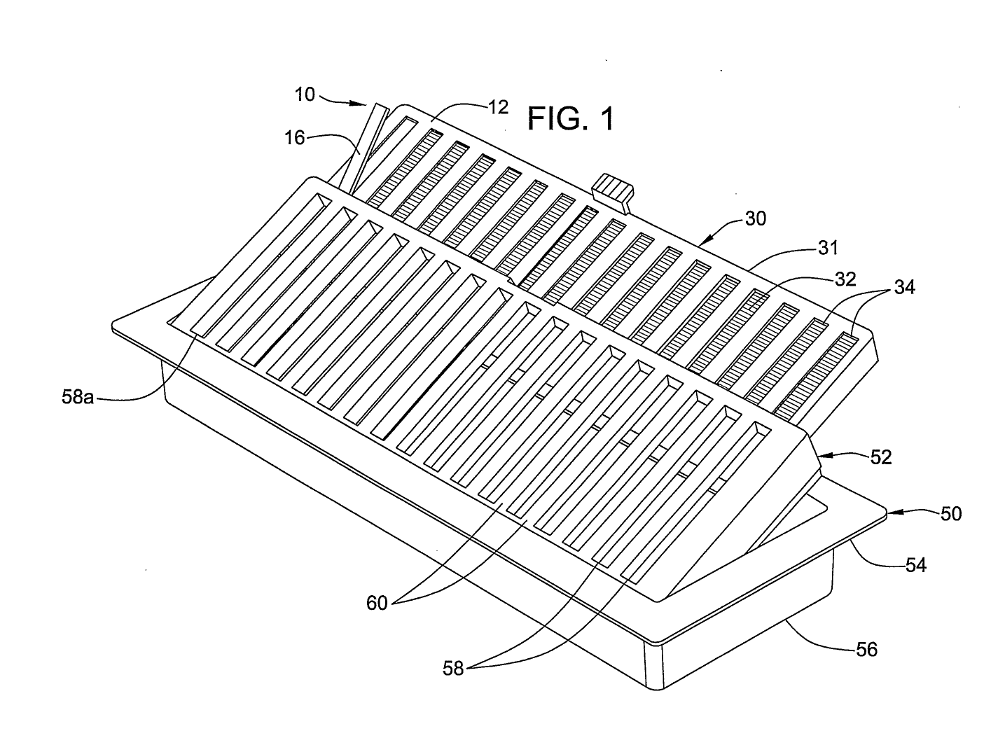

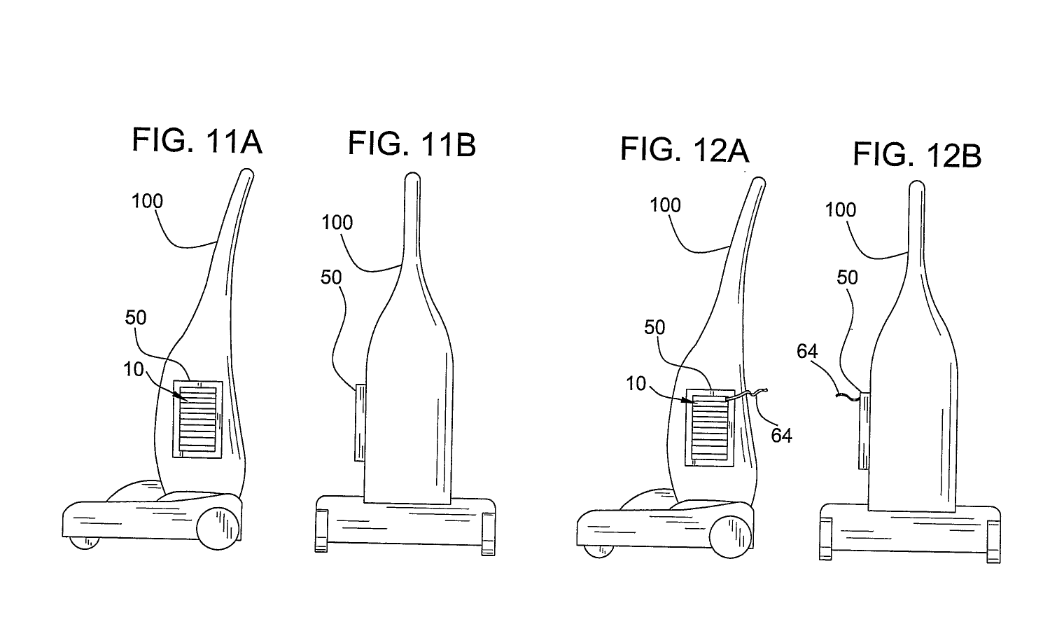

Referring next to the drawings, wherein the same reference numerals refer to the same elements, FIG. 1 depicts a perspective view of one embodiment of a filter alert device 10 made according to the present invention that alerts a user that a filter may require replacement or maintenance. In the preferred embodiment shown in FIG. 1, the filter alert device 10 is shown as an integral part of a register filter 30 that may be incorporated into a conventional register 50 of an HVAC system (not shown) or a device such as a vacuum cleaner 100 shown in FIGS. 11-12.

In the HVAC application, one or more registers 50 are typically used as inlets and outlets to distribute forced air from the HVAC system into and out of rooms. The register 50 is typically located in the walls, floors, or ceilings of a room and/or mounted in an HVAC unit. The register 50 may have a rectangular profile as shown in the drawings, or a circular or other profile desired by the user. Registers 50 typically have a filter housing 52 that holds the filter 30, a face panel 54 that covers the peripheral edge of the HVAC duct opening and forms an aesthetically pleasing appearance, and sides 56 that extend outwardly and penetrate into HVAC ducts to anchor the register 50. One example of a register and register filter are described in U.S. Pat. No. 6,234,893, entitled “Vent Device for Use with Medium for Alerting a Condition of Air Entering an Environment,” which is herein incorporated by reference.

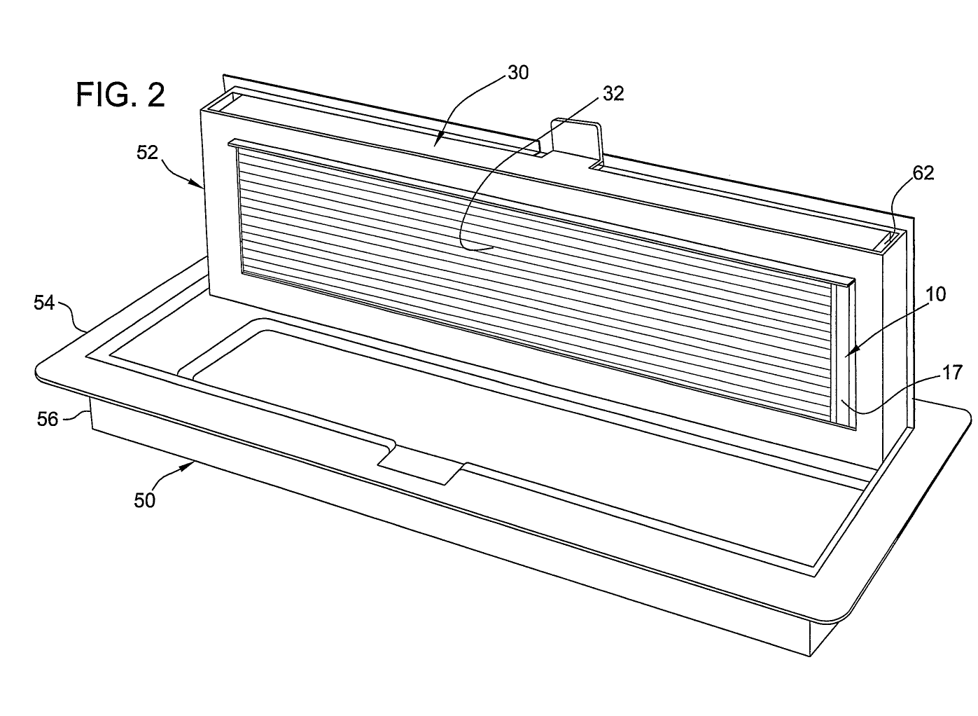

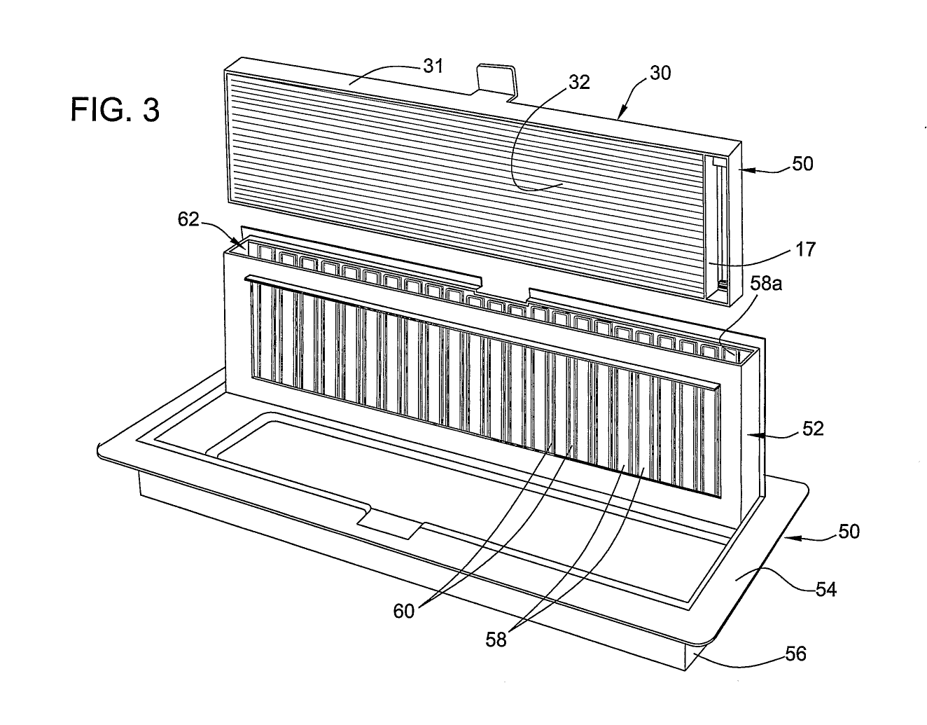

In the illustrated embodiment, the filter housing 52 is rotatably mounted in a door-like fashion so that it may be positioned between closed and open positions. In the open position shown in FIGS. 1-3, the filter housing 52 projects outwardly from the room surface so that the filter 30 may be slidably inserted into or removed from a groove 62 (best shown in FIGS. 2 and 3). When the filter housing 52 is in the closed position shown in FIG. 4, the register 50 forms a generally flat surface that is flush with the room ceiling, wall or floor and the forced air from the HVAC system must pass through the filter 30 to enter the room. The filter housing 52 also has one or more register openings 58 that permit forced air to be introduced into the room after passing through the filter 30. The register openings 58 may be arranged in any desired pattern, shape, and size, such as the generally rectangular openings formed by the louvers 60 shown in the drawings. The louvers 60 may be fixedly attached to the filter housing 52 or adjustably attached to the housing 52 to provide further control of the amount of air introduced into the room.

Referring to FIGS. 1 and 5, it will be seen that the filter 30 has a generally rectangular frame 31 or other shape that generally corresponds to the register 50 and fits into the filter housing 52. The frame 31 holds a conventional filter medium 32 that is suitable for removing undesirable contaminants from the conditioned air before the air is introduced into the room through filter openings 34 in the filter frame 31. The filter opening 34 generally corresponds to the shape and location of the register openings 58 so that air may freely pass through the aligned openings 58, 34 when the filter 30 is inserted into the filter housing 52. It will be appreciated that, as the filter 30 becomes contaminated, the air pressure increases and, at a predetermined contamination level and air pressure, the filter 30 must be cleaned or replaced.

In the embodiments shown in FIGS. 1-5, the filter alert device 10 has a frame 12 that defines at least one opening 14, an indicator or flap 16 rotatably attached to the frame 12 so that the indicator 16 may rotate between open and closed positions, and an attachment mechanism 20 that releasably holds the indicator 16 in the closed position. In the illustrated embodiment, the filter alert frame 12 is integrally attached to one end of the filter frame 31 but, in other embodiments, the filter alert frame 12 may be integrally attached to the register 50 or even a separate unit that may be releasably attached to the filter frame 31 or the register 50. Since the illustrated embodiment of the filter alert device 10 is an integral part of the filter 30, the indicator opening 14 and the filter openings 34 are in the filter frame 31. The indicator 16 is rotatably attached to a pivot 18 at a bottom portion of the frame 12, but may be attached to other portions of the frame 12 as long as the indicator 16 may rotate outwardly of the indicator opening 14. The pivot 18 may be an integral part of the frame 12 or a separate piece that is attached to the frame 12.

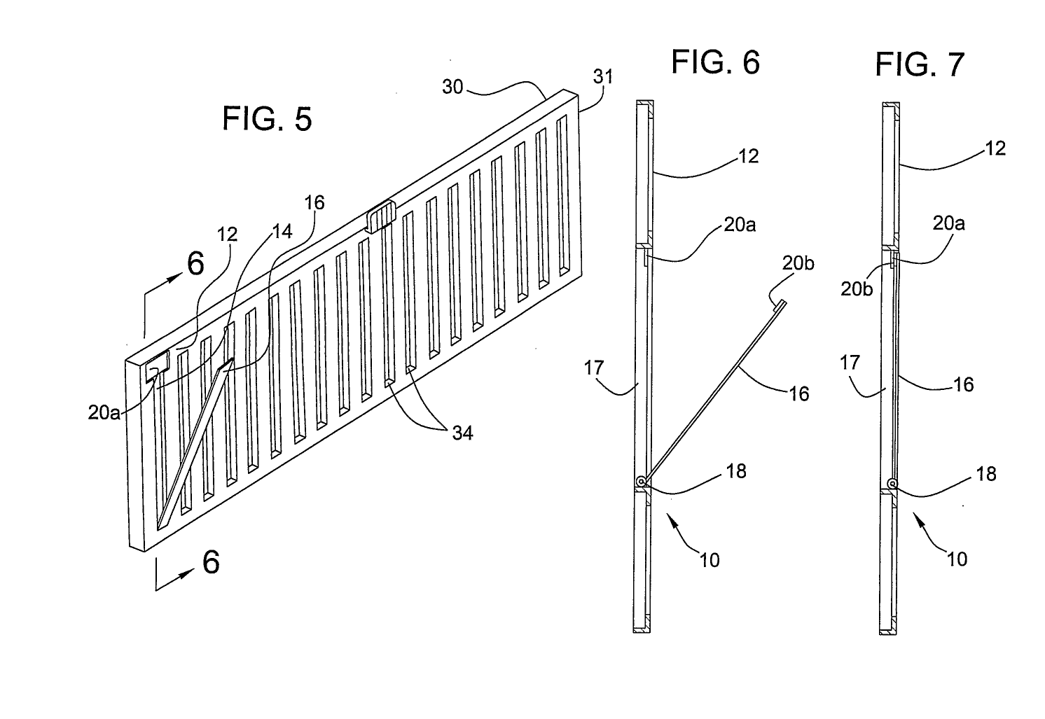

When the indicator 16 is in the closed position as shown in FIG. 7, the indicator 16 covers the opening 14 and prevents the conditioned air from passing through the opening 14. In the closed position, the indicator 16 is also positioned within the outer boundaries of the filter frame 12 so that the filter may be inserted into or removed from the filter housing 52. In the open position shown in FIGS. 1 and 4-6, the indicator 16 extends outwardly from the indicator opening 14 and filter frame 12 and conditioned air may pass through the opening 14. Since the indicator 16 is in communication with the forced air from the HVAC system, it will be appreciated that the same air pressure is exerted on the filter medium 32 and the indicator 16.

To permit the indicator 16 to move towards the open position when the filter 30 is inserted into the filter housing 52, the filter alert device 10 should be positioned on the filter 30 so that the indicator 16 and the register opening 58a are generally aligned with each other. When properly aligned, the indicator 16 may rotate from the closed position to the open position, wherein the indicator 16 extends out of the register opening 58a and serves as a visual alert to the user that the filter 30 is dirty and needs to be replaced or cleaned.

Since the filter alert device 10 has a cavity 17 in communication with the forced air from the HVAC system, the forced air exerts pressure on the indicator 16 that tends to force the indicator 16 towards the open position. In accordance with the present invention, the attachment element 20a, 20b has a securing force that releasably attaches the indicator 16 and the indicator frame 12 and secures the indicator 16 in the closed position. The securing force is pre-selected so that it resists the outward air pressure on the indicator 16 and prevents the indicator 16 from rotating from the closed position shown in FIG. 7 to the open position shown in FIGS. 1 and 4-6 until the forced air exceeds a predetermined threshold pressure that indicates that the filter 30 must be cleaned or replaced. Once the air pressure exceeds the predetermined threshold pressure, the air pressure on the indicator 16 overcomes the securing force and the indicator 16 rotates out of the indicator opening 14 and register opening 58a and into the open position as shown in FIGS. 1 and 4. In the open position, the outwardly projecting indicator 16 alerts the user that the filter 30 needs to be cleaned or replaced and allows conditioned air to flow through the opening 14 until the filter 30 is replaced. In an alternative embodiment, a piece of flexible material, such as a colored ribbon, string and the like, may be attached to indicator 16 to act as a further visual alert for the user.

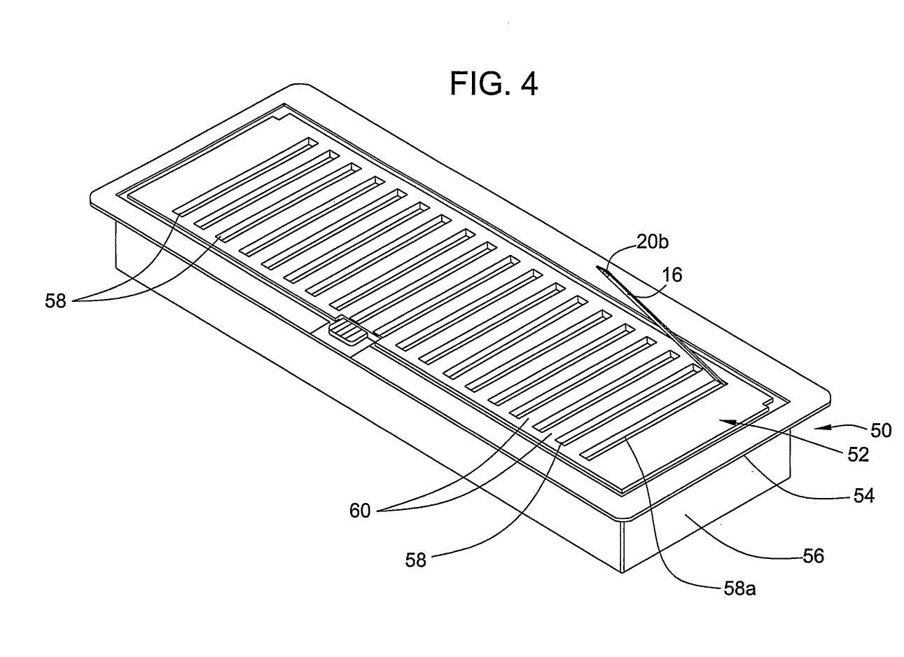

In the illustrated embodiment best shown in FIGS. 6-7, the attachment mechanism 20 comprises a magnet 20a and metal foil 20b that are selected so that the attractive magnetic force is about the same as the predetermined threshold pressure. The magnet 20a is preferably attached inside the indicator opening 14 to minimize the weight of the indicator, but may be attached to the indicator 16 if desired. If the indicator 16 is a non-magnetic material, a small piece of the metallic foil 18b may be attached by glue or other means to indicator 16.

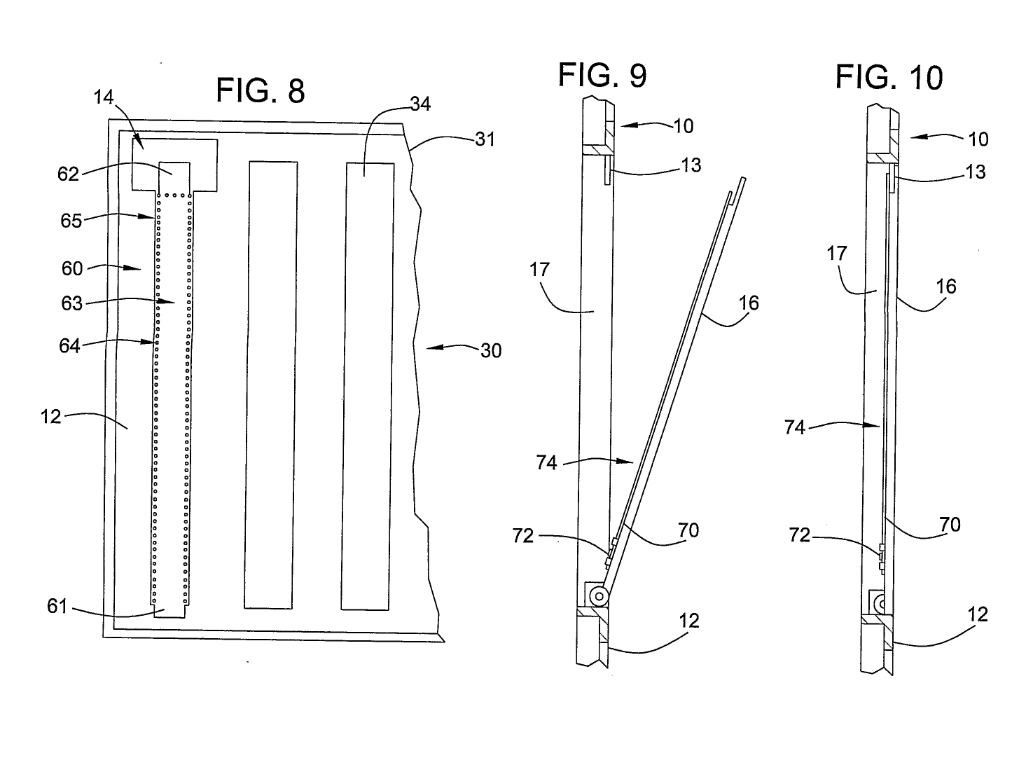

Persons of ordinary skill will appreciate that the present invention is not limited to the illustrated embodiments and that an exhaustive list need not be provided. In another embodiment, for example, shown in FIG. 8, the indicator 60 that covers the indicator opening 14 may made of a material, such as a ribbon, fabric and the like, that may be perforated. First and second portions 61, 62 of the indicator 60 are attached to the opening 14 using adhesive, pins and the like. The attachment mechanism 65 that attaches a third portion 63 of the indicator 60 comprises a plurality of perforations 64 having a securing force less than the predetermined pressure and is designed to break away in response to the predetermined pressure. Once the predetermined pressure is reached, the perforations 64 tear or break and permit the third portion 64 of the indicator to move to the open position, thereby alerting users to the condition of the filter 30. In other embodiments, the attachment mechanism 65 may be an adhesive having a securing force designed to release the indicator at the predetermined pressure. This embodiment of the filter alert device has been incorporated into a vacuum cleaner 100 shown in FIGS. 11-12. In the illustrated vacuum cleaner 100, a filter is mounted in the housing 50 and the filter alert device is an integral part of the filter as discussed above. During normal operation, when the filter is operating properly, the indicator 60 remains in the closed position shown in FIGS. 11a, 11b. Once the filter is contaminated, the air pressure will increase, overcome the securing force of the indicator 60 so that indicator moves to the open position (shown in FIGS. 12a, b) and thereby alert the user that the filter needs to be changed and/or cleaned.

In yet another embodiment shown in FIG. 9, the attachment mechanism 70 may comprise a spring. One end of the spring 70 may be mounted to the frame 12 using conventional retainers 72 such as bosses and the like. In the closed position shown in FIG. 10, the other end of the spring 70 is retained by a shelf or edge 13 on the frame 12. The spring biasing force is selected so that it is less than the predetermined pressure. Once the air pressure in the cavity 74 exerts a pressure on the indicator 16 that exceeds the spring biasing force, the spring 70 will flex past the shelf 13 and so that the indicator 70 may move out of the indicator opening to the open position shown in FIG. 9. The spring 70 may be adjusted to a wide range of pressures, for example, by changing diameter and flexure ability or the spring length extending on the shelf area 13.

In the embodiments illustrated in the drawings, the frame 12 is an integral part of the filter frame 31. Importantly, those skilled in the art will appreciate the wide variety of positions that the alert indicator may be located, such that an exhaustive list need not be provided for those skilled in the art to appreciate the broad scope of the present invention. For example, in other embodiments, it may be attached to other parts of the filter frame 31 or the filter medium 32 as long as the indicator 16 may extend out of a register opening, 58 and alert the user to the filter's condition. In addition, rather than mounting the alert device 10 to the filter 30, it may be mounted to the register 50, register housing 52, or in a register opening 58, in which case the flap may extend outwardly from the register in the open position. Rather than forming the filter alert device 10 as an integral element of the filter or register, the filter alert device 10 may also be a separate element that is releasably attached to the filter frame 12 or register 50 using conventional attachment devices such as adhesive, hook and latch devices, screws and the like. In these embodiments, the filter alert device 10 is in communication with at least a portion of the air so that the indicator 16 may be positioned between the closed and open positions in response to the air pressure.

Although the invention has been described and illustrated with respect to exemplary and preferred embodiments, it should be understood by those skilled in the art that the foregoing and various other changes, additions and modifications may be made to such embodiments, without departing from the spirit and scope of the present invention.

What is claimed is:

1. A register filter alert device comprising:
a register having a filter housing in communication with air, and at least one opening that allows air to pass through the register;
a filter releasably secured in the filter housing so that it may remove contaminants from the air, and wherein the air creates a pressure that varies in response to the flow through the filter and the life of the filter and a predetermined air pressure that indicates when air is no longer able to pass through the filter at acceptable pressure levels and the life of the filter has been exceeded;
a frame defining a cavity in communication with the air;
an indicator attached to the frame for movement between open and closed positions wherein (1) the filter is operating within desired operating parameters when the indicator is in the closed position and (2) the filter is no longer operating within desired operating parameters when the indicator is in the open position;
a pressure-responsive attachment element coupling the indicator and frame so that the indicator is retained in the closed position when the air pressure is below the predetermined pressure and the filter is operating within desired parameters and the indicator is released in response to air pressures that exceed the predetermined pressure and may move to the open position and visually signal that the filter is no longer operating within desired operating parameters.

2. The device as set forth in claim 1 wherein the frame defines a frame opening that positioned such that the indicator aligns with the register opening when the frame is mounted to the filter and the indicator may pass through the register opening in the open position.

3. The device as set forth in claim 1 wherein the indicator comprises a rigid flap pivotally attached to the frame for movement between the closed and open positions, and wherein the flap projects outwards from the frame to visually signal that the filter is no longer operating within desired operating parameters.

4. The device as set forth in claim 3 wherein the attachment element comprises a first magnetic element attached to one of the flap and frame, a second magnetic element attached to the other of the flap and frame, and a securing force between the first and second magnetic elements that is less than the predetermined pressure exerted on the flap so that predetermined pressure may overcome the securing force and permit the flap to move towards the open position.

5. The device as set forth in claim 1 wherein the indicator comprises first, second and third portions, wherein the first and second portions are secured to the frame, and wherein the attachment element comprises a plurality of perforations for attaching the second and third portions, and the plurality of perforations having a securing force that breaks in response to the predetermined pressure so that the third portion projects outwardly to visually signal that the filter is no longer operating within desired operating parameters.

6. The device as set forth in claim 2 wherein the attachment element comprises an adhesive coupling the flap and frame that has a securing force that is less than the predetermined pressure exerted on the flap so that predetermined pressure may overcome the securing force and permit the flap to move towards the open position.

7. A filter alert device for use with an air filter used to distribute air, wherein the air pressure exceeds a predetermined pressure when the air is unable flow through the filter at desired pressure levels and the life of the filter has been exceeded, the filter alert device comprising:
a frame defining an opening in communication with a portion of the air delivered to the filter, and an indicator attached to the frame for movement between closed and open positions wherein (1) the indicator remains in closed position to show that the filter is operating within desired operating parameters and (2) the indicator is positioned to the open position to show that the filter is no longer operating within desired operating parameters;
a pressure sensitive attachment device that couples the indicator to the frame in the closed position when the pressure is below the predetermined value and the filter is operating within desired parameters and releases the indicator when the pressure exceeds the predetermined pressure and the filter is no longer operating within desired operating parameters.

8. The device as set forth in claim 7 wherein the indicator comprises a rigid flap pivotally attached to the frame for movement between the closed and open positions, and wherein the flap projects outwards from the frame to visually signal that the filter is no longer operating within desired operating parameters.

9. The device as set forth in claim 8 wherein the attachment element comprises a first magnetic element attached to one of the flap and frame, a second magnetic element attached to the other of the flap and frame, and a securing force between the first and second magnetic elements that is less than the predetermined pressure exerted on the flap so that predetermined pressure may overcome the securing force and permit the flap to move towards the open position.

10. The device as set forth in claim 8 wherein the attachment element comprises an adhesive coupling the flap and frame that has a securing force that is less than the predetermined pressure exerted on the flap so that predetermined pressure may overcome the securing force and permit the flap to move towards the open position.

11. The device as set forth in claim 7 wherein the indicator comprises first, second and third portions, wherein the first and second portions are secured to the frame, and wherein the attachment element comprises a plurality of perforations for attaching the second and third portions, and the plurality of perforations having a securing force that breaks in response to the predetermined pressure so that the third portion projects outwardly to visually signal that the filter is no longer operating within desired operating parameters.

12. The device as set forth in claim 7 wherein the attachment element comprises an adhesive to the indicator and frame that has a securing force that is less than the predetermined pressure exerted on the indicator so that predetermined pressure may overcome the securing force and permit the indicator to move towards the open position.

13. The device as set forth in claim 7 comprising a register housing that has at least one register opening, and wherein the frame is mounted to the register housing such that the indicator may pass through the register opening in the open position.

14. The device as set forth in claim 7 comprising a register housing that houses the filter and defines at least one register opening the passes air from the filter, and wherein the frame is mounted to the filter and the indicator aligns with the register opening so that the indicator may pass through the register opening in the open position.
